(19) United States
(12) Patent Application Publication
(10) Pub. No.: US 2011/0027463 A1
(43) Pub. Date: Feb. 3, 2011

(54) WORKPIECE HANDLING SYSTEM

(75) Inventors: Benjamin B. Riordon, Newburyport, MA (US); Kevin M. Daniels, Lynnfield, MA (US); William T. Weaver, Austin, TX (US); Charles T. Carlson, Cedar Park, TX (US)

Correspondence Address: VARIAN SEMICONDUCTOR EQUIPMENT ASSC., INC., 35 DORY RD., GLOUCESTER, MA, 01930-2297, US

(73) Assignee: VARIAN SEMICONDUCTOR EQUIPMENT ASSOCIATES, INC., Gloucester, MA (US)

(21) Appl. No.: 12/814,748

(22) Filed: Jun. 14, 2010

Related U.S. Application Data
(60) Provisional application No. 61/187,306, filed on Jun. 16, 2009.

(51) Int. Cl. B05D 5/00; B05C 13/00; B05D 1/32

(52) U.S. Cl. 427/75; 118/500; 118/503; 427/282

(57) ABSTRACT

A workpiece handling system includes a process chamber configured to support a workpiece for ion implantation, a first mask stored outside the process chamber in a mask station, and a robot system configured to retrieve the first mask from the mask station, and position the first mask upstream of the workpiece so the workpiece receives a first selective implant through the first mask. A method includes storing a first mask outside a process chamber in a mask station, retrieving the first mask from the mask station, positioning the first mask upstream of a workpiece positioned in the process chamber for ion implantation, and performing a first selective implant through the first mask.

### Cross Reference to Related Applications

This application claims the benefit of provisional patent application number 61/187,306 filed Jun. 16, 2009 which is incorporated herein by reference.

### FIELD

This disclosure relates to workpiece handling, and, more particularly, to a workpiece handling system and methods of operation.

### BACKGROUND

Workpiece handling systems generally introduce workpieces into a process chamber of a process tool, remove the same from the process chamber, and return the same to a workpiece carrier after processing. The processing of the workpieces in the process chamber is typically performed in vacuum. The processing tool may be an ion implanter that generates and directs ions towards a surface of the workpiece for treatment. The ion implanter may be a beam line ion implanter or plasma doping ion implanter. A beam line ion implanter includes an ion source and an extraction electrode assembly to extract a well defined ion beam from the ion source. One or more beamline components known in the art may control and modify the ion beam to obtain an ion beam with desired characteristics which is directed towards a front surface of the workpiece. The ion beam may be distributed across the front surface of the workpiece by ion beam movement, workpiece movement, or a combination of the two. An ion implanter may also include known plasma doping ion implanters that generate plasma in a chamber. Ions from the plasma are attracted towards a front surface of a workpiece during certain time intervals. The workpiece is also positioned in the chamber of the plasma doping ion implanter. For either type of ion implanter, the workpiece may include, but not be limited to, a solar cell, a semiconductor substrate, a polymer substrate, and a flat panel.

The workpiece being treated by an ion implanter may have a photoresist mask to expose selected portions of the workpiece to the ions and to protect other portions from ions. While this photoresist masking procedure is precise, it adds multiple steps to the device production process with associated costs. Any reduction in costs to the manufacturing process, especially to solar cell manufacturing where cost per watt is a driving issue, is desirable.

Accordingly, there is a need for an improved workpiece handling system.

### SUMMARY

According to a first aspect of the disclosure a workpiece handling system is provided. The workpiece handling system includes a process chamber configured to support a workpiece for ion implantation, a first mask stored outside the process chamber in a mask station, and a robot system configured to retrieve the first mask from the mask station, and position the first mask upstream of the workpiece so the workpiece receives a first selective implant through the first mask.

According to another aspect of the disclosure, a method is provided. The method includes storing a first mask outside a process chamber in a mask station, retrieving the first mask from the mask station, positioning the first mask upstream of a workpiece positioned in the process chamber for ion implantation, and performing a first selective implant through the first mask.

The present disclosure will now be described in more detail with reference to exemplary embodiments as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a workpiece handling system consistent with an embodiment of the disclosure;

FIG. 2A is a cross sectional view of a clamping assembly consistent with an embodiment of the disclosure with lift pins in an elevated position;

FIG. 2B is a view of the clamping assembly of FIG. 2A with the lift pins in a retracted position;

FIG. 3 is a view of one type of mask that may be used in the workpiece handling system of FIG. 1;

FIG. 4 is a cross sectional view of a selective emitter solar cell that can be fabricated with the mask of FIG. 3;

FIG. 5 is a view of another type of mask that may be used in the workpiece handling system of FIG. 1;

FIG. 6 is a cross sectional view of an interdigitated back contact solar cell that may can be fabricated with the mask of FIG. 5;

FIG. 7 is a view of a desired implant region pattern;

FIG. 8 is a view of one mask that would provide the desired implant region pattern of FIG. 7 but is extremely difficult to manufacture;

FIG. 9 is a view of two masks that together can provide the desired implant region pattern of FIG. 7; and

FIG. 10 is a bock diagram of a mask station having a heater.

### DETAILED DESCRIPTION

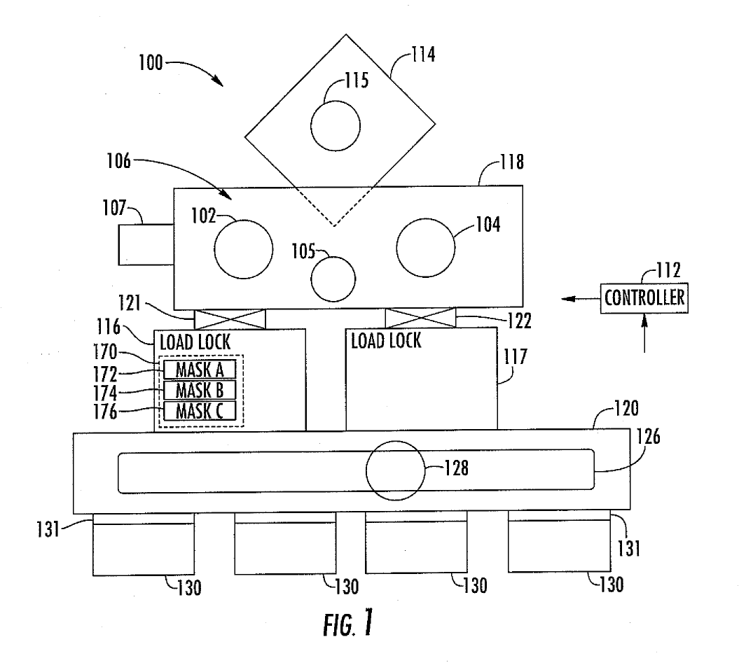

FIG. 1 is a block diagram of a workpiece handling system 100 having a process chamber 114, one or more masks 172, 174, 176 stored outside the process chamber 114 in a mask station 170, and a robot system 106 including one or more robots such as a first vacuum robot 102, a second vacuum robot 104, and an atmospheric robot 128. The mask station 170 enables a variety of masks 172, 174, 176 to be stored therein and to be accessed by associated robots of the robot system 106. Accordingly, the workpiece handling system 100 permits flexibility in selecting different masks for different purposes depending on the type of workpiece and the desired selective treatment thereto in the process chamber 114. Although the mask station 170 is illustrated as being in the first load lock 116, the mask station 170 may be in another location accessible to one or more of the robots of the robot system 106. For instance, the mask station 170 may be in the second load lock 117, the workpiece handler chamber 118, the buffer chamber 120, or another specially designed chamber such as chamber 107 attached to one side of the workpiece handler chamber 118. The chamber 107 may communicate with the workpiece handler chamber 118 through isolation valves (not illustrated).

The workpiece handling system 100 may also include the buffer chamber 120, load locks 116, 117, and the workpiece handler chamber 118. The buffer chamber 120 may be at or near atmospheric pressure and provides a controlled, low particulate environment. The buffer chamber 120 may interface with workpiece carriers 130 through a door 131. The workpiece carriers 130 may be a standardized workpiece carrier depending on the workpiece. The workpiece may include, but not be limited to, a solar cell, a semiconductor substrate, a polymer substrate, and a flat panel. For a semiconductor substrate used in semiconductor processing, the workpiece carrier 130 may be a front opening unified pod (FOUP), which is a standardized carrier for transporting semiconductor substrates in fabrication facilities. The buffer chamber 120 may also include the atmospheric robot 128 to transport workpieces along a track 126, and to move workpieces between the wafer carriers 130 and the load locks 116, 117. In another instance, the buffer chamber 120 may be replaced with a belt-style system to move workpieces along a belt, and two scan arm robots to deliver workpieces to the load locks 116, 117.

The load locks 116, 117 may communicate with the workpiece handler chamber 118 through isolation valves 121, 122 respectively. The workpiece handler chamber 118 may include the first vacuum robot 102, the second vacuum robot 104, and a workpiece alignment station 105 or orienter.

A vacuum pumping system (not illustrated) controls pressure in differing chambers including, but not limited to, the load locks 116, 117. In particular, when a workpiece is transferred from the buffer chamber 120 to the first load lock 116 by the atmospheric robot 128, the first load lock 116 is vented to the pressure of the buffer chamber 120, typically atmosphere, with the isolation valve 121 closed. Then a valve connecting the first load lock 116 and the buffer chamber 120 is closed and the load lock chamber vacuum pumped to the pressure of the workpiece handler chamber 118. Then, the isolation valve 121 is opened and workpieces and one or more masks 172, 174, 176 may be accessed by the first vacuum robot 102.

The controller 112 can be or include a general-purpose computer or network of general-purpose computers that may be programmed to perform desired input/output functions. The controller 112 also includes communication devices, data storage devices, and software. The controller 112 may receive signals from a user interface system and/or one or more components of the workpiece handling system 100 and may control operation of the same 100 in response thereto.

In operation, the controller 112 may control the workpiece handling system 100 to selectively retrieve a workpiece from one of the load locks 116, 117 and position it on a clamp 115 of the process chamber 114. For example, the first vacuum robot 102 of the robot system 106 may select a workpiece from the first load lock 116 through the open isolation valve 121 and position it on the clamp 115 for ion implantation. For a “blanket” implant of ions, no mask would be positioned upstream of the workpiece in a direction defined by the travel of ions towards the workpiece. For a selective implant, one or more desired masks 172, 174, 176 may be positioned upstream of the workpiece. For example, while the blanket implant is taking place a succeeding selective implant may be desired so the first vacuum robot 102 may select “Mask A” 172 from the mask station 170 positioned in the first load lock 116 in this instance. After proper orientation by the workpiece alignment station 105, the first robot 102 may position “Mask A” 172 upstream of the workpiece already on the clamp 115 to that a selective implant through non-blocking portions of this mask may be initiated.

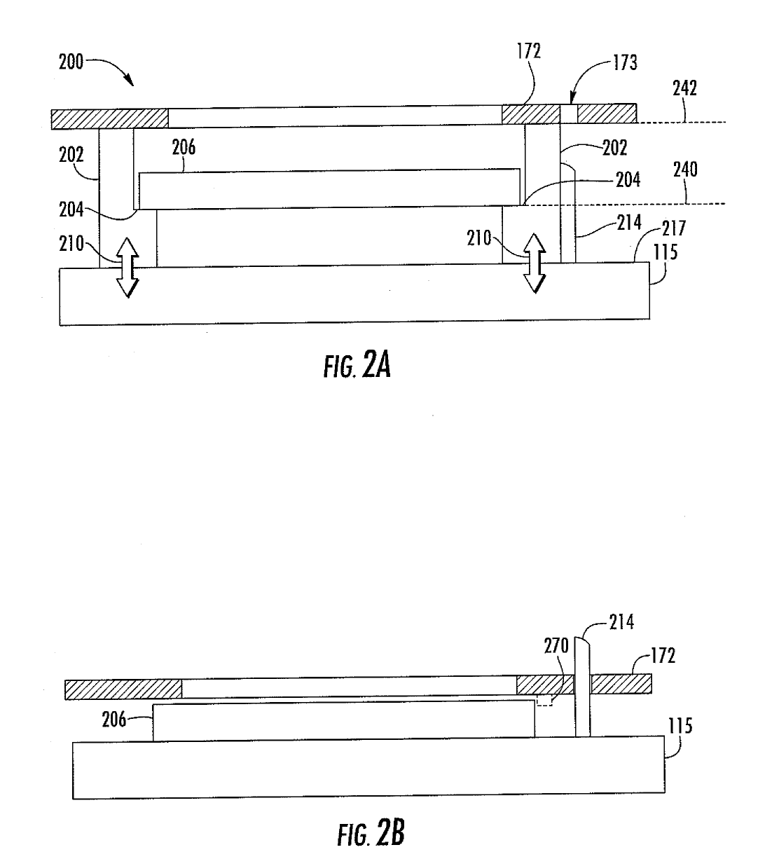

Turning to FIGS. 2A and 2B, cross sectional views of a clamping assembly 200 consistent with an embodiment are illustrated with lift pins 202 in an extended (FIG. 2A) and fully retracted position (FIG. 2B). To facilitate insertion and removal of the workpiece 206 and/or mask 172, the lift pins 202 may be in the extended position of FIG. 2A. During processing when ions are striking the workpiece through openings in the mask 172, the lift pins may be in the fully retracted position of FIG. 2B. The lift pins 202 may extend and retract in the direction of the arrows 210.

The clamping assembly 200 facilitates the introduction and removal of differing workpiece and mask combinations to the clamp 115 and accurate alignment of the same. As illustrated in FIG. 2A, the lift pins 202 may have a stepped structure where a shelf 204 of each lift pin 202 can support a portion of the workpiece 206 on a first load plane 240. Another portion of the lift pins 202 defines a second load plane 242 for a mask such as the mask 172. Two different load planes 240, 242 permit the use of a dual pick having two end effectors where desired. Alternatively, two separate robots with a single end effector on each robot can be utilized. In another instance, both the mask 172 and workpiece 206 may be abutting each other on a single end effector.

The clamping assembly 200 also includes an alignment mechanism to ensure proper alignment of the mask 172 to the workpiece 206. The mask 172 may have an alignment feature that is referenced to another portion of the clamping assembly 200. In the embodiment of FIGS. 2A & 2B, the alignment feature of the mask 172 is an aperture 173 that is aligned with a post 214. The post 214 extends from a clamping surface 217 of the clamp 115. As shown in FIG. 2B, when the mask 172 is properly aligned, the post 214 is aligned with the associated aperture 173 of the mask. In another alignment mechanism consistent with the disclosure, a protrusion 270 shown in phantom on FIG. 2B on an underside of the mask 172 facing the workpiece 206 can facilitate proper alignment of the mask 172 to the workpiece 206. The clamping assembly 200 also fixes the relative positioning of the mask 172 to the workpiece 206 for processing in the process chamber 114. That is, the mask 172 and the workpiece 206 move together at the same rate through ions in the process chamber 114.

In another clamping assembly embodiment, the single stepped lift pins 202 may be replaced with two separate sets of lift pins. One set of lift pins may be provided to support the workpiece 206 on a first load plane and a second set of lift pins may be provide to support the mask 172 on a second load plane.

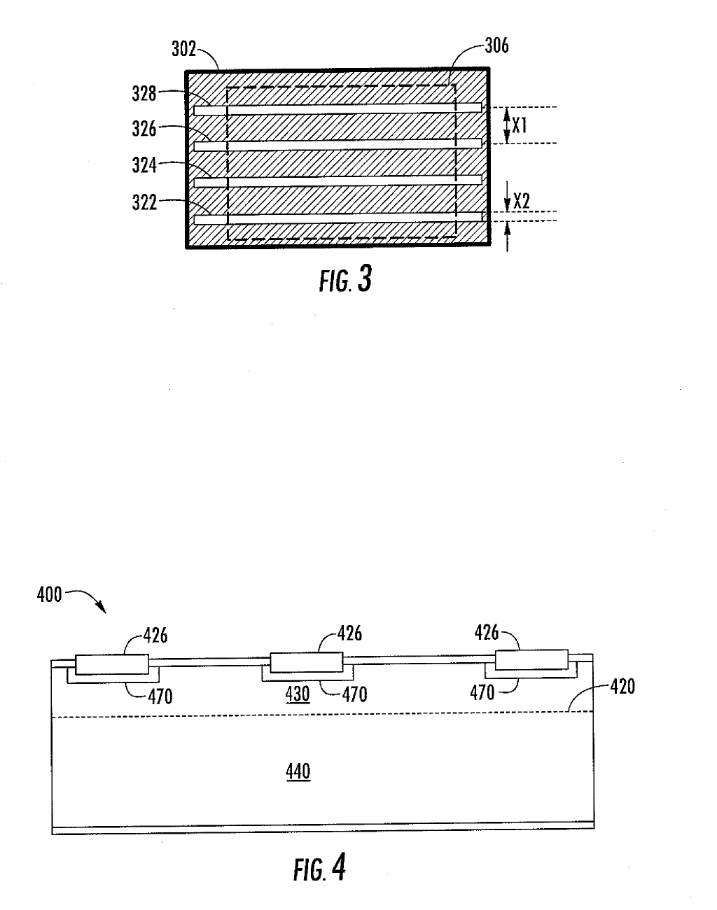

The mask station 170 can store one or more masks 172, 174, 176 of differing sizes and shapes useful for differing purposes and implant patterns. Turning to FIG. 3, a view of one embodiment of a simplified mask 302 looking downstream in the direction of travel of ions is illustrated. The mask 302 may also be stored in the mask station 170 and utilized in the workpiece handling system 100. A workpiece 306 positioned downstream of the mask 302 is illustrated in phantom. The workpiece 306 in this example may be a selective emitter solar cell and may be later referred to as such. The mask 302 may be fabricated of graphite or another material that sufficiently blocks ions. The mask 302 is illustrated as having four apertures 322, 324, 326, 328 for clarity of illustration only. In actuality, the mask 302 may have many more apertures depending on the center to center spacing (X1) between apertures and the width (X2) of each aperture. In one embodiment, the mask 302 may have center to center spacing (X1) of about 2-3 millimeters and each aperture may have a width (X2) of about 150-700 micrometers to permit selective doping for a selective emitter solar cell 306.

During a first ion implant step, the mask 302 is not upstream of the workpiece to enable a “blanket” implant to be performed on the selective emitter solar cell workpiece 306 for a lightly doped emitter region. During a second ion implant step, the robot system 106 via the first vacuum robot 106 may retrieve the desired mask 302 from the mask station 170 and position it upstream of the selective emitter solar cell workpiece 306. These steps may be reversed so that the masked implant is performed first and the “blanket” implant is performed thereafter. Regardless of the order, the mask 302 blocks ions from striking certain portions of the lightly doped emitter region while allowing ions to strike elongated portions having a length and a width defined by the apertures 322, 324, 326, 328. These elongated portions of heavily doped regions are positioned beneath where front side electrical contracts or “fingers” of the selective emitter solar cell will later be added.

More particularly with reference to FIGS. 1, and 3, six selective emitter solar cells may be loaded in a 2×3 matrix onto a carrier sized to carry the same. This carrier may be loaded into the first load lock 116 by the atmospheric robot 128. A mask such as mask 302 may already be stored in the mask station 170. In one instance, a vertical storage location in the first load lock 116 may alternately store carriers and masks. The first vacuum robot 102 may retrieve a carrier from the first load lock 116 and after orienting it with the wafer alignment station 105 position the same on the clamp 115 in the process chamber 114. The six selective emitter solar cells on the carrier may then receive a first blanket ion implant. While the blanket implant is taking place, the first robot 102 may retrieve a mask such as mask 302 from the mask station 170 and later position it upstream of the carrier after the blanket implant is completed. Again, the order of these steps may be reversed.

A selective implant may then be performed through the mask 302 to form more heavily doped regions. The mask 302 and carrier holding six selective emitter solar cells may then be removed at the same time by the second vacuum robot 104. The treated selective emitter solar cells on the carrier may then be position in the second load lock 117 while the mask 302 may be returned to the mask station 170. The isolation valve 122 may then be closed and the second load lock 117 vented to the same pressure as the buffer chamber 120, typically atmosphere. The treated selective emitter solar cells may then be retrieved by the atmospheric robot 128 and positioned in one of the workpiece carriers 130 for future transport.

Turning to FIG. 4, a cross sectional view of a selective emitter solar cell 400 that can be fabricated in part with the workpiece handling system of FIG. 1 and a mask consistent with the mask 302 of FIG. 3 is illustrated. The selective emitter solar cell 400 has a lightly doped region 430 and more heavily doped regions 470. The lightly doped region 430 may be an n-type region to form a p-n junction 420 between a p-type base 440 and the lightly doped n-type region 430. Those skilled in the art will recognize the p-type and n-type regions may be reversed. The lightly doped region 430 may be formed by the blanket implant while the more heavily doped regions 470 may be formed by the selective implant through the apertures 322, 324, 326, 328 of the mask 302. The heavily doped regions 470 placed under the front side contacts 426 improve conductivity between the contacts 426 and the solar cell. Hence, the efficiency of the solar cell is also improved.

Turning to FIG. 5, a view of one embodiment of another mask 502 looking downstream in the direction of travel of ions is illustrated. The mask 502 is another example of a mask may also be stored in the mask station 170 and utilized in the workpiece handling system 100. A workpiece positioned downstream of this mask 502 may be an interdigitated back contact (IBC) solar cell. The mask 502 is one of two masks that are useful in doping differing regions of the IBC solar cell.

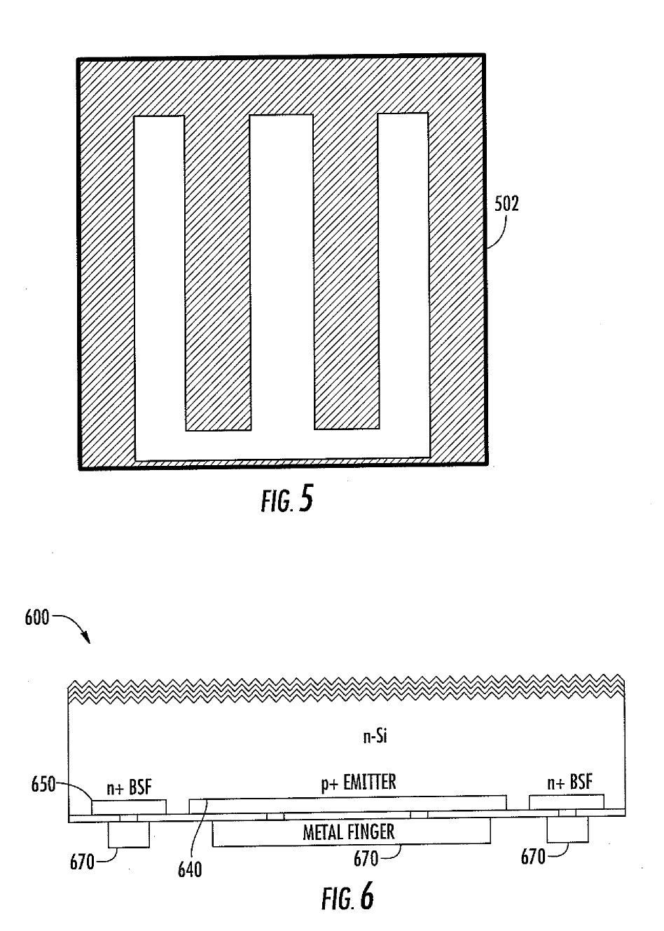

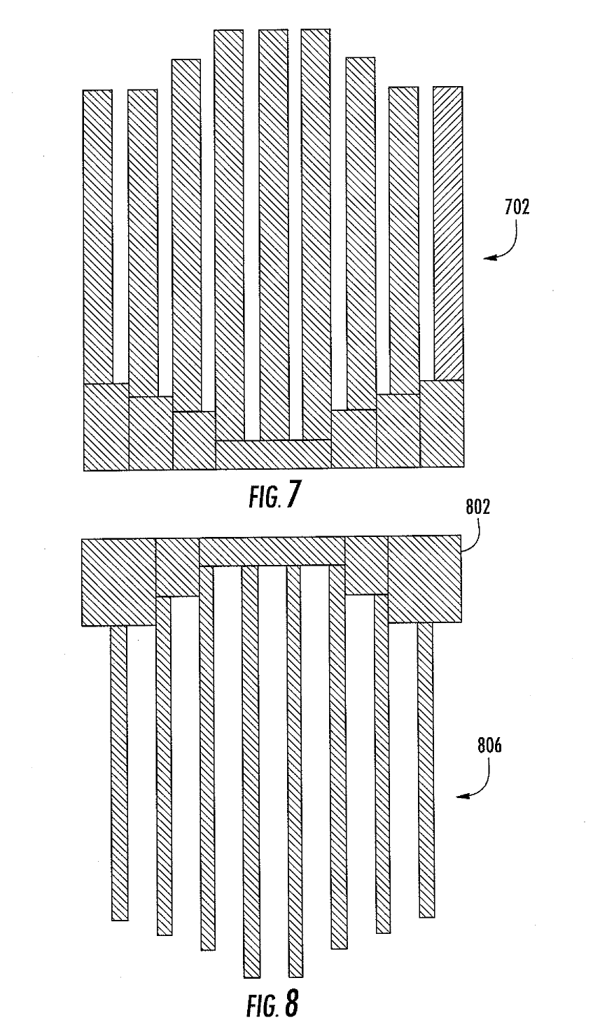

FIG. 6 is a cross sectional view of an IBC solar cell 600 that can be fabricated in part with the workpiece handling system of FIG. 1 and the mask 502 of FIG. 5 is illustrated. The IBC solar cell is known in the art and has metallic contacts 670 located on the bottom surface of the substrate. Certain portions of the bottom surface may be implanted with p-type dopants to create an emitter region 640. Other portions may be implanted with n-type dopants to create more negatively biased back surface field (BSF) region 650. In operation, a first mask may be stored outside the process chamber 114 in the mask station 170. A robot of the robot system 106 may retrieve the first mask and position it upstream of the IBC solar cell 600. A selective implant may then be performed through non-blocking portions of the first mask with an n-type dopant. This selective implant through the first mask may define the back surface field region 650 of the IBC solar cell 600. While the first selective implant through the first mask is taking place, the robot system 106 may retrieve a second mask similar to the mask 502 of FIG. 5 from the mask station 170. The first mask may be removed from the process chamber 114 and returned back to the mask station 170. Meanwhile, the mask 502 may be retrieved and positioned upstream of the IBC solar cell. A second selective implant with a p-type dopant through the mask 502 may then be performed to form the emitter region 640. This sequence of implants with two different masks allows the creation of the contact pattern required for IBC solar cells. The order of forming the back surface field region 650 and the emitter region 640 may also be reversed by first forming the emitter region 640 and then forming the back surface field region 650.

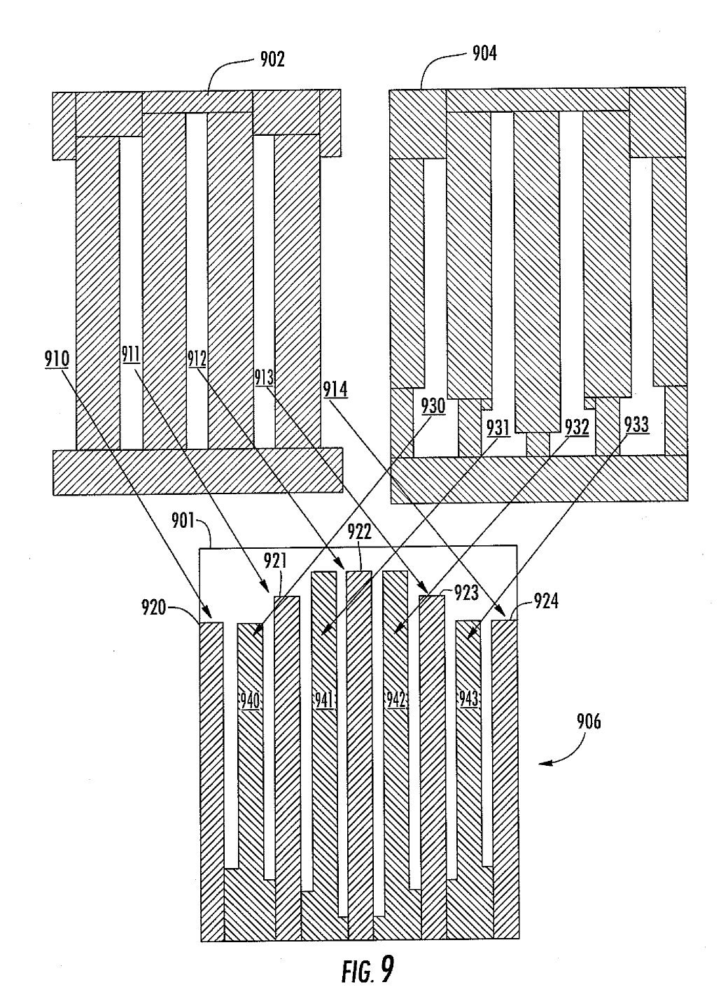

The flexibility of the workpiece handling system 100 also enables two or more masks to be used in succession, or simultaneously, to achieve a desired implant pattern that may otherwise be extremely difficult or impossible to achieve with only one mask. For example, turning to FIG. 7, a desired implant pattern 702 is illustrated. If only one mask was manufactured to provide the desired implant pattern 702 of FIG. 7, the mask 802 may be shaped as illustrated in FIG. 8. Unfortunately, the mask 802 shape of FIG. 8 having elongated narrow portions 806 is difficult, if not impossible, to manufacture with typical mask materials such as graphite. Even if possible to manufacture, such a mask 802 would prone to damage and difficult to handle.

Advantageously, as illustrated in FIG. 9, the desired implant pattern 702 of FIG. 7 can be achieved with a first mask 902 and a second mask 904 used in succession, or simultaneously to achieve a desired aggregate selective implant pattern 906 that is the same as the desired pattern 702 of FIG. 7. Compared to the mask 802 of FIG. 8, the masks 902 and 904 do not have elongated narrow portions and are more easily manufactured and less prone to damage when handling.

In operation, the robot system 106 may retrieve the first mask 902 from the mask station 170 and position the same upstream of a workpiece 901 to be treated with ions. The openings 910, 911, 912, 913, 914 in the first mask 902 permit the doped regions 920, 921, 922, 923, 924 illustrated in one fill pattern to be formed on the workpiece 901. The first mask 902 may then be removed from its position upstream the workpiece, the robot system 106 may retrieve the second mask 904 from the mask station 170 and position the same upstream of the workpiece 901. The openings 930, 931, 932, 933 in the second mask 904 permit the doped regions 940, 941, 942, 943 illustrated in another fill pattern to be formed on the same workpiece 901. In this way, the first selective implant through the first mask 902 and the second selective implant through the second mask 904 together provide a desired aggregate selective implant patter 906 that is the same as the desired implant pattern 702 of FIG. 7.

The mask station 170 can additionally provide for thermal treatment of the one or more masks stored therein. Such thermal treatment helps to control and minimize variations due to thermal expansion of the one or more masks since the mask tends to heat up when in use as ions strike the same. The thermal treatment may include cooling, heating, or both.

Passive cooling may be provided by allowing masks returned to the mask station 170 to sufficiently cool before using again. For instance, when the mask station 170 is subject to atmospheric conditions such as in the load locks 116, 117 or in the buffer chamber 120, exposure to the atmospheric conditions alone tends to cool the masks as heat is more readily conducted away from the mask by the ambient air. Active cooling may include the addition of one or more cooling units (not illustrated) in the mask station 170 to actively provide for even additional cooling. The additional cooling unit may be a gas cooling assembly or a cooling station where cryogenic fluids are pumped through the cooling station. Cooling may be employed to pre-cool a mask to below ambient temperature before use of the same, or back to about ambient temperature from a higher temperature after its use.

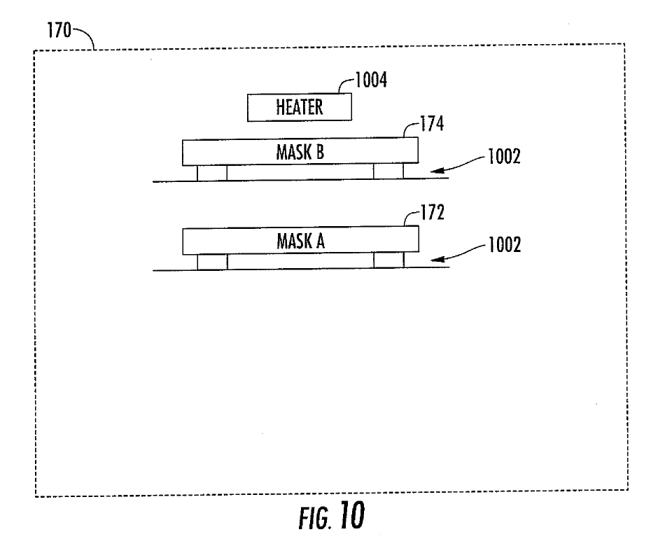

As illustrated in FIG. 10, the mask station 170 may also provide for heating of one or more masks. Similarly to cooling, one or more masks may be heated in order to minimize variations of the mask due to thermal expansion. In one embodiment, a heater 1004 may be positioned proximate the mask 174 to provide for active heating of the same. The heater 1004 may be implemented as a heated surface located above the mask. The heater 1004 may also be located below the mask or in any position proximate the mask to provide the desired heat. The heater 1004 may provide additional heat to the mask 174 to minimize radiational cooling of the same or to heat the mask to a predetermined high temperature range. Furthermore, a mask such as mask 172 may be positioned on non-thermally conductive pads 1002 without any heater to heat the mask 172. The non-thermally conductive pads 1002 minimize heat loss of the mask 172.

Accordingly, there is provided a workpiece handling system that provides for flexibility in selecting one or more different masks for different purposes. Many different work flow processes with one or more masks may be implemented. Rapid process changes are therefore enabled. In addition, the workpiece handling system can be readily adapted to an existing ion implanter that is not equipped with any masks. The mask station 170 can be selected to provide for access to inspect or exchange any mask therein while the ion implanter is still operating. Accordingly, the throughput of the ion implanter is not adversely impacted by ongoing mask inspections or mask exchanges. For example, in one embodiment a window may be place on the chamber 107 to provide for visual mask inspection. Other types of mask inspection may also take place.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A workpiece handling system comprising:
a process chamber configured to support a workpiece for ion implantation;
a first mask stored outside the process chamber in a mask station; and
a robot system configured to retrieve the first mask from the mask station, and position the first mask upstream of the workpiece so the workpiece receives a first selective implant through the first mask.

2. The workpiece handling system of claim 1, further comprising a load lock chamber, and wherein the mask station is positioned in the load lock chamber.

3. The workpiece handling system of claim 1, further comprising a clamping assembly positioned in the process chamber to support the workpiece for ion implantation, the clamping assembly comprising:
a clamp having a clamping surface to support the workpiece; and
two retractable lift pins extending from the clamping surface in an extended position, the two retractable lift pins defining a first plane to support the workpiece and a second plane to support the first mask in the extended position.

4. The workpiece handing system of claim 3, wherein the clamping assembly further comprises a post extending from the clamping surface of the clamp, the post sized to engage an associated aperture in the first mask to facilitate alignment of the first mask and the workpiece as the two retractable lift pins are retracted to a retracted position.

5. The workpiece handling system of claim 1, further comprising a second mask stored outside the process chamber in the mask station, and wherein the robot system is further configured to retrieve the second mask, position the second mask upstream of the workpiece so the workpiece receives a second selective implant through the second mask, wherein the first selective implant and the second selective implant together provide a desired aggregate selective implant pattern.

6. The workpiece handling system of claim 1, wherein the mask station comprises a plurality of non-thermally conductive pads to support the first mask when stored at the mask station.

7. The workpiece handling system of claim 1, wherein the mask station comprises a heater to heat the first mask when stored at the mask station.

8. The workpiece handling system of claim 1, wherein the mask station comprises a cooling unit to cool the first mask when stored at the mask station.

9. A method comprising:
storing a first mask outside a process chamber in a mask station;
retrieving the first mask from the mask station;
positioning the first mask upstream of a workpiece positioned in the process chamber for ion implantation; and
performing a first selective implant through the first mask.

10. The method of claim 9, further comprising returning the first mask to the mask station after performing the first selective implant.

11. The method of claim 9, further comprising:
storing a second mask in the mask station;
retrieving the second mask from the mask station;
positioning the second mask upstream of the workpiece positioned in the process chamber for ion implantation; and
performing a second selective implant through the second mask, wherein the fist selective implant and the second selective implant together provide a desired aggregate selective implant pattern.

12. The method of claim 11, wherein the first mask and the second mask are both positioned upstream of the workpiece simultaneously.

13. The method of claim 11, wherein the first mask and the second mask are positioned upstream of the workpiece in succession.

14. The method of claim 9, wherein the workpiece comprises a selective emitter solar cell and the first selective implant implants ions into elongated portions of the selective emitter solar cell to form heavily doped regions having a length and a width positioned beneath front side contacts of the selective emitter solar cell.

15. The method of claim 14, further comprising implanting the selective emitter solar cell with a blanket implant unimpeded by the first mask, the blanket implant providing a p-n junction in the selective emitter solar cell.

16. The method of claim 9, wherein the workpiece comprises an interdigitated back contact (IBC) solar sell, and the first selective implant implants ions into portions of the IBC solar cell to form back surface field region of an n-type dopant.

17. The method of claim 16, further comprising
retrieving a second mask from the mask station;
positioning the second mask upstream of the workpiece positioned in the process chamber for ion implantation; and
performing a second selective implant through the second mask to implant implants ions into other portions of the IBC solar cell to form an emitter region of a p-type dopant.

18. The method of claim 9, further comprising positioning the first mask on a plurality of non-thermally conductive pads in the mask station.

19. The method of claim 9, further comprising cooling the first mask in the mask station.
